(19) United States
(12) Patent Application Publication
(10) Pub. No.: US 2002/0057417 A1
(43) Pub. Date: May 16, 2002

(54) Polysaccharide coating of contact lenses

(76) Inventor: Miles A. Galin, New York, NY (US)

Correspondence Address: BAKER & BOTTS, L.L.P., 30 ROCKEFELLER PLAZA, NEW YORK, NY, 10112, US

(21) Appl. No.: 10/034,179

(22) Filed: Dec. 26, 2001

Related U.S. Application Data
(63) Continuation of application No. 09/631,864, filed on Aug. 3, 2000, now abandoned.
(63) Continuation of application No. 09/253,280, filed on Feb. 19, 1999.
(60) Provisional application No. 60/146,921, filed on Aug. 3, 1999.

(51) Int. Cl. G02C 7/02; B30B 1/00; C08L 1/00; C08J 3/00; C08K 3/00

(52) U.S. Cl. 351/166; 351/177; 523/106

(57) ABSTRACT

The present invention provides a method of modifying surfaces of contact lenses to reduce bacterial, fungal or viral concentration and adherence. The method of the invention comprises the coating of a contact lens surface with a sulfated polysaccharide such as heparin to reduce the concentration of microorganisms, as well as bacterial, fungal or viral adherence. The invention further relates to compositions comprising contact lenses for correcting vision deficiencies of the eye coated with a sulfated polysaccharide such as heparin. Contact lens surfaces as provided in accordance with this invention have a coating of sulfated polysaccharide which reduces the concentration of microorganisms of all types and prevents the adherence of bacteria, fungi or viruses to the lens surface thereby reducing the potential for infection.

### INTRODUCTION

The present invention provides a method of modifying the surface of contact lenses to reduce bacterial, fungal or viral adherence and presence. The method of the invention comprises the coating of a contact lens surface with a sulfated polysaccharide such as heparin to reduce the concentration of microbiological flora as well as the level of bacterial, fungal or viral adherence. The invention further relates to compositions comprising contact lenses for correcting vision deficiencies of the eye coated with a sulfated polysaccharide such as heparin. Contact lens surfaces as provided in accordance with this invention have a coating of sulfated polysaccharide which reduces the adjacent microbiological flora and prevents the adherence of bacteria, fungi or viruses to the lens surface thereby reducing the potential for infection.

### BACKGROUND OF THE INVENTION

Eye care products, such as contact lenses, are susceptible to contamination by ocular pathogens. Such pathogens, including bacteria, fungi, protozoans and viruses, have been found to cause diseases of the eye including infectious keratitis, conjunctivitus and uveitis. Of the approximately 20 million contact lens wearers in the United States, over 12,000 infections are estimated to occur yearly. Thus, wearing of contact lenses poses a risk of serious, painful complications, including corneal ulceration from infection, which can lead to blindness.

Various agents have been found to be effective in killing or reducing the growth of pathogens. For example, U.S. Pat. No. 4,499,077 discloses an antimicrobial composition for treatment of soft contact lenses comprising an oxidizing agent such as an oxyhalogen compound; and U.S. Pat. No. 4,654,208 discloses an antimicrobial composition for contact lenses including a germicidal polymeric nitrogen compound. In addition, contact lenses may be manufactured to incorporated specific compounds having antimicrobial activities into the lens material. For example, U.S. Pat. No. 5,770,637 discloses contact lenses prepared from polymers that contain metal chelators that make such metals unavailable to pathogens such as bacteria.

Intraocular lenses have been coated with sulfated polysaccharides, such as heparin, for prevention of coagulation, inflammation and activation of complement as described in U.S. Pat. No. 4,240,163.

Despite quality manufacturing and sterilizing methods that have reduced inflammation due to mechanical and chemical causes and surface coatings that have reduced inflammation, microbial contamination of contact lenses remains a serious and ever present problem. Thus, methods that lead to the creation of a barrier to preventing bacterial, fungal or viral adherence or penetration of the lens surface are desirable for reducing the potential for ocular infection.

### SUMMARY OF THE INVENTION

The present invention relates to a method of modifying the surface of a contact lens to reduce concentration of adjacent pathogens as well as to reduce bacterial, fungal or viral adherence. The method of the invention comprises the coating of a contact lens surface with a sulfated polysaccharide such as heparin. The invention further provides compositions comprising contact lenses coated with a sulfated polysaccharide such as heparin for reducing the potential of infection. Lens surfaces as provided in accordance with this invention have a coating of sulfated polysaccharide such as heparin which reduces microbial organism concentration and reduces the adherence of bacteria, fungi or viruses to the lens surface.

Other objects and advantages of the invention will be apparent to those skilled in the art, from a reading of the following detailed description of the preferred embodiments, and the appended claims.

### DETAILED DESCRIPTION OF THE INVENTION

The present invention relates to the coating of the surface of a contact lens with a sulfated polysaccharide such as heparin to reduce bacterial, fungal or viral presence and adherence to said contact lens. The surface of contact lenses including but not limited to soft, hydrophilic hydrogels, soft hydrophobic elastomers, rigid, gas permeable or hard PMMA lenses, may be coated with sulfated polysaccharide to enhance their safety. Further, coating of contact lenses with such sulfated polysaccharides will enhance their hydrophilicity thereby creating a more lubricious surface resulting in a more comfortable contact lens.

The present invention is directed to a method of preparing contact lenses coated with a sulfated polysaccharide, such as heparin, comprising the steps of first activating the surface of the lens, for example, by exposing an uncoated lens to a plasma to generate a plasma-treated lens having a surface containing amines, carboxylic acids, active free radicals or passive free radicals, and thereafter bonding the sulfated polysaccharide to the plasma-treated lens surface.

Contact lenses of this invention include hard poly (methylmethacrylate), rigid gas permeable lenses, soft hydrogel lenses and gas permeable silicon based hydrogels. In addition, hydrophobic materials such as silicone elastomers can also be utilized. All these lenses may be coated with a surface polysaccharide such as heparin. Lenses containing collagen can also be treated in the same fashion.

The coating of the present invention may be bonded to the surface of the lens by any method of bonding well known by those skilled in the art, preferably in such a manner that the coating is bonded to the surface of the lens by means of covalent bonding, ionic attraction, or hydrogen bonding, with covalent bonding being particularly preferred. Either end point and/or midpoint attachment of the sulfated polysaccharide may be accomplished for effective reduction of adhesion. In one particularly preferred embodiment of this invention, heparin is covalently bonded to the surface of the lens by means of an end-group attachment of heparin to the lens surface.

In another particularly preferred embodiment, the lens surface is first treated with a plasma to generate an amine-containing surface, a carboxylic acid containing-surface, or an active or passive free radical-containing surface, and heparin compounds or derivatives thereof are thereafter employed to coat the lens surface.

In one embodiment, plasma treating is accomplished by setting the lens in a gaseous atmosphere such as an oxygen rarefied atmosphere, and subjecting the lens to an electromagnetic field for a given period of time. In one embodiment the lens may be subjected from 1-10 minutes, for example 2 minutes to an electromagnetic field having a frequency in the range of 1-50 MHZ, for example about 10-15 MHZ with a corresponding power range of 10-500 W/cm², for example about 100 W/cm².

In another embodiment, in accordance with techniques well known to those skilled in the art, plasma treating is accomplished by applying a voltage between electrodes wherein the uncoated lens resides between the electrodes in the presence of a gas, thereby causing a highly ionized gas to bombard the lens surface so as to cause the desired constituent (i.e. amine, carboxylic acid, active free radical, or passive free radical) to reside in the lens surface. The gas employed may comprise a carrier gas, either alone or in combination with other gases. The carrier gas may be any gas, but argon or air are preferred, with argon gas typically being used. The pressure of the gas is typically between 1.0 and 3,000 torr. Equipment which may be employed to achieve such plasma treating is well known to those skilled in the art, such as the equipment described in U.S. Pat. No. 4,780,176 (Sudarshan et al.) for plasma cleaning and etching a metal substrate, which is incorporated herein by reference. In the present invention, a power input to the electrode of 10-500 W may be employed to achieve a corresponding potential difference across the gap between the electrode and lens.

To generate an amine-containing surface, a plasma containing ammonia or a primary amine-containing material is used. A carboxylic acid-containing surface is generated by an oxidative reaction occurring at the surface or by having residual water in the plasma under inert conditions. In such an embodiment, argon is typically used as the carrier gas. Exposing the surface to argon gas plasma at sufficiently high power causes bond fission, yielding an active free radical-containing surface, whereas exposing the surface to oxygen or air plasma under oxidizing conditions results in a passive free radical-containing surface.

The method of coating the contact lens of this invention may be any appropriate well known coating technique, such as immersion coating, spray coating and the like, using a suitable solution or dispersion of the medicament dissolved or dispersed in an appropriate solvent or dispersant, such as water, ethanol, and the like, with the solvent not affecting the optics of the lens material. The coating solution or dispersion has a conventional concentration of polysaccharide corresponding to the particular coating technique selected. Typically, after the coating is applied to the lens, it is dried, for example, by drying at room temperature or above. The coating may be repeatedly applied, if necessary, to achieve the desired coating weight or thickness. The coating should not affect the transmission of visual light, and typically has a thickness in the range of from about 1/100,000 mm to 1/100 mm, and constitutes from about 1/10,000% to about 1/10% by weight of the implant.

The sulfated polysaccharide coating employed in conjunction with the contact lens in this invention is preferably selected from the group consisting of heparin, heparin sulfate, chondroitin sulfate, dermatan sulfate, chitosan sulfate, xylan sulfate, dextran sulfate, and sulfated hyaluronic acid. Heparin is particularly preferred for use as the coating, with heparin having a molecular weight in the range of about 2,500-15,000 daltons. If low molecular weight heparins are employed they can be prepared by enzymatic hydrolysis or depolymerization of heparin with heparinase as disclosed, for example, by U.S. Pat. No. 3,766,167 (Lasker et al.), or by depolymerizing either heparin residues or commercial porcine or bovine heparin by reacting the heparin material with a blend of ascorbic acid and hydrogen peroxide, the reaction products then being isolated and fractionated by precipitation using an organic solvent, such as ethanol, methanol, acetone, or methyl ethyl ketone. Commercially available heparin may also be cleaved chemically using nitrous acid to yield lower molecular weight heparin, including heparin having a molecular weight in the range of about 2500-10,000 daltons, preferably 2500-5300 daltons.

Additional compounds may also be employed in conjunction with the compatible sulfated polysaccharide coating of the present invention, for example, compounds that inhibit fogging or beading may also be utilized.

### EXAMPLE 1

Lenses fabricated of poly (methylmethacrylate) were obtained. Heparin (10 g) was dissolved in distilled water (200 ml) with sodium periodate (1 g). The solution was stirred in the dark at room temperature for 12 hours. After addition of glycerol (10 ml), the solution was dialized for 12 hours against distilled water (15 l). The water changed every second hour. The oxidized heparin was further processed by lyophilization (yield 8.2 g). The lenses were thoroughly rinsed with water and etched by treatment with a aqueous solution of ammonium peroxidisulphate (5% w/v) for 30 min at 60° C. After rinsing in water, the lenses were treated with an aqueous solution of polyethyleneimine (0.05% w/v) at pH 3.9 at room temperature for 10 min. After rinsing with water, the treatment was repeated as described above with the modification that the etching procedure was omitted and that the treatment with oxidized heparin was preformed for 120 min the generated Schiff base is induced and finally the heparinized lenses were rinsed first with borate buffer pH 9.0, then with water and left to dry at room temperature. The presence of heparin coating may be established semiquantitatively by staining with toluidine blue (0.02% w/v in water) and quantitatively with the MBTH (3-methyl-2-benzothiazoloine hydrzone) method (Risenfeld J. et al., 1990, Analyt Biochem 188:383-389).

### EXAMPLE 2

An uncoated contact lens in accordance with this invention and containing surface carboxyl groups is surface coated with low molecular weight heparin (i.e. about 2,500-5,300 daltons) by the following procedure. The carboxyl group-containing surface of the contact lens may preferably be made by initially incorporating about 5 weight percent methacrylic acid into the monomer formulation used in preparing the lens. Alternatively, surface hydrolysis of pendant acrylate or methacrylate groups residing on the surface of the lens may be employed, in a manner well known to those skilled in the art. The pendant carboxylic acid groups on the surface of the lens are then reacted with a commercially available diamine, such as hexamethylene diamine or a polymeric di amine such as those commercially available under the JEFFAMINE series trade name from Texaco Chemical Company, in the presence of a water-soluble carbodimide coupling agent, to generate an amine grafted surface (through amide bond formation) where the non-attached portion of the amine resides as a free primary amine. To the free primary amine grafted surface is added the low molecular weight heparin that contains a terminal aldehyde group, and the aldehyde group is then coupled with the primary amine on the surface of the lens by a water-soluble carbodimide to yield a Schiff base, which is then reduced to give a secondary amine linkage to which is attached the low molecular weight heparin.

### EXAMPLE 3

In another preferred embodiment, an uncoated lens in accordance with this invention and containing surface carboxyl groups, is obtained in accordance with Example 1. However, instead of reacting the surface carboxylic groups with a diamine, as in Example 1, an aldehyde-terminated heparin is first coupled with a diamine. This reaction utilizes an excess of diamine, such as a low molecular weight, water-soluble diamine, that reacts with the aldehyde-terminated heparin through one of its amine groups, generating an amido-bonded heparin derivatized with a free, pendant amino group. This water-soluble compound is then purified by dialysis to eliminate the excess, unreacted diamine, and the product obtained by lyophilization. The aminated heparin is then reacted with the hydrolyzed surface of the contact lens through its surface carboxyl groups in the presence of a water-soluble carbodiimide coupling agent. In contrast to the previously described embodiment of Example 1, this process involves only one coupling reaction on the surface of the lens rather than two.

### EXAMPLE 4

In yet another preferred embodiment, an uncoated lens in accordance with this invention is treated with a plasma in accordance with methods as previously described to generate an amine-containing surface, a carboxylic acid-containing surface, or an active or passive free radical-containing surface. If an amine-containing surface is obtained, aldehyde-terminated heparin may be employed to coat the surface of the lens in accordance with Example 1. If a carboxylic acid-containing surface is obtained, aminated heparin may be employed to coat the surface of the lens in accordance with Example 2. If an active or passive free radical-containing surface is obtained, amine or carboxylic acid-containing compounds of low or high molecular weight may be reacted with the surface to yield a covalently attached amine or carboxylic acid-containing lens surface, respectively, to which the designated aldehyde-terminated or aminated heparin compounds set forth in Examples 1 and 2, respectively, are employed to coat the surface of the lens with heparin. In a particularly preferred embodiment, the plasma treatment employed will act in such a manner as to permit trace surface moisture residing in the uncoated lens to be converted into passive free radical coupling agents via the formation of peroxide groups.

Although this invention has been illustrated by reference to specific embodiments, it will be apparent to those skilled in the art that various changes and modifications may be made which clearly fall within the scope of this invention.

What is claimed:

1. A contact lens having a surface coating comprising a compatible sulfated polysaccharide.

2. The contact lens according to claim 1, in which the sulfated polysaccharide is selected from the group consisting of heparan, heparin sulfate, chondroitin sulfate, dermatan sulfate, chitosan sulfate, xylan sulfate, dextran sulfate, and sulfated hyaluronic acid.

3. The contact lens according to claim 2, in which the sulfated polysaccharide is heparin having a molecular weight in the range of about 2,500-15,000 daltons.

4. The contact lens according to claim 3, in which the heparin has a molecular weight in the range of about 2,500-10,000 daltons.

5. The contact lens according to claim 4, in which the heparin has a molecular weight in the range of about 2,500-5,300 daltons.

6. The contact lens according to claim 1, in which the coating is covalently bonded to the surface of the lens.

7. The contact lens according to claim 1, in which the coating is bonded by hydrogen bonding to the surface of the lens.

8. The contact lens according to claim 6, in which heparin is covalently bonded to the surface of the contact lens by means of an end-group attachment of heparin to the lens surface.

9. A method of preparing a contact lens having a surface coating comprising a compatible sulfated polysaccharide, the method comprising the steps of first exposing an uncoated lens to a plasma to generate a plasma-treated lens having a surface with constituents selected from the group consisting essentially of amines, carboxylic acids, active free radicals, and passive free radicals, and thereafter bonding the sulfated polysaccharide to the plasma-treated lens surface.

10. The method according to claim 9, in which the sulfated polysaccharide is heparin having a molecular weight in the range of about 2,500-15,000 daltons.

11. A method according to claim 9, in which the plasma-treated lens has an amine-containing surface comprising primary amines.

12. A method according to claim 9, in which heparin is bonded to the amine-containing surface by contacting the amine-containing surface with heparin containing a terminal aldehyde group, coupling the aldehyde group to the primary amines to produce a Schiff base, and thereafter reducing the Schiff base to produce a secondary amine linkage between the heparin and lens surface.

13. A method according to claim 9, in which the plasma-treated lens has a carboxylic acid-containing surface.

14. A method according to claim 9, in which heparin is bonded to the carboxylic acid-containing surface by first coupling an aldehyde-terminated heparin with a diamine to generate an aminated heparin, and thereafter contacting the aminated heparin with the carboxylic acid-containing surface in the presence of water-soluble carbodimide coupling agent.
